(19) United States
(12) Patent Application Publication
(10) Pub. No.: US 2018/0374447 A1
(43) Pub. Date: Dec. 27, 2018

(54) METHOD FOR DRIVING DISPLAY PANEL, DATA SOURCE AND DISPLAY APPARATUS

(71) Applicant: BOE TECHNOLOGY GROUP CO., LTD., Beijing (CN)

(72) Inventor: Saichang Yun, Beijing (CN)

(73) Assignee: BOE TECHNOLOGY GROUP CO., LTD., Beijing (CN)

(21) Appl. No.: 15/742,602

(22) PCT Filed: Jul. 28, 2017
(86) PCT No.: PCT/CN2017/094899

§ 371 Date: Jan. 8, 2018

(30) Foreign Application Priority Data
Sep. 30, 2016 (CN) 201610877432.X

(51) Int. Cl. G09G 3/36

(52) U.S. Cl. CPC G09G 3/3688; G09G 2310/08; G09G 3/3648

(57) ABSTRACT

The present application discloses a method for driving a display panel, a data source, and a display apparatus. The method includes providing, during a time period of displaying a frame of image and through a data line, a first data signal having a first slew rate to a first pixel electrode in a first region and a second data signal having a second slew rate higher than the first slew rate to a second pixel electrode in a second region. The first pixel electrode in the first region and the second pixel electrode in the second region are coupled to the same data line. The second region is on a side of the first region distal to a data source configured to input the first data signal and the second data signal.

### CROSS-REFERENCE TO RELATED APPLICATION

This application claims priority to Chinese Patent Application No. 201610877432.X, filed Sep. 30, 2016, the contents of which are incorporated by reference in the entirety.

### TECHNICAL FIELD

The present invention relates to display technology, particularly to a method for driving display panel, a data source, and a display apparatus.

### BACKGROUND

Liquid crystal display (LCD) apparatuses have many advantages including low power consumption, high display quality, being radiation free, and have found a wide range of applications in display field. In a typical LCD apparatus display process, in each time period of display a frame of image, a gate driving circuit sequentially generates a gate scanning signal transmitted via one gate line after another to turn on all thin-film transistors (TFTs) connected to one row of pixel electrodes after another row. After all TFTs connected to each row of pixel electrodes are turned on, data signals generated by a data line driving circuit are transmitted through respective data lines to charge each pixel electrode for displaying different gray scales of brightness based on respective data signals. Due to overlapping regions existed between the data line and other components of the display panel, a parasitic capacitance is induced in the data line itself to cause transmission delay of the data signal on the data line.

### SUMMARY

In an aspect, the present disclosure provides a method of driving a display panel. The method includes providing, during a time period of displaying a frame of image and through a data line, a first data signal having a first slew rate to a first pixel electrode in a first region and a second data signal having a second slew rate higher than the first slew rate to a second pixel electrode in a second region. The first pixel electrode in the first region and the second pixel electrode in the second region are coupled to the same data line, the second region being on a side of the first region distal to a data source configured to input the first data signal and the second data signal.

Optionally, the first data signal having the first slew rate in a first region is provided through a first data line and the second data signal having the second slew rate in the second region is provided through a second data line, wherein the second slew rate is higher than the first slew rate and the second region is on a side of the first region distal to the data source.

Optionally, the method of providing the first data signal and the second data signal includes providing each of N numbers of data signals with different slew rates respectively to a pixel electrode in one of N non-overlapping regions, where N is an integer greater than or equal to 2 and no greater than a total number of gate lines in the display panel. The pixel electrode in any of the N non-overlapping regions more distal to the data source is provided with one of the N numbers of data signals having a slew rate higher than that of one of the N numbers of data signals provided to the pixel electrode of the N non-overlapping regions more proximal to the data source.

Optionally, each of the N non-overlapping regions includes one or more gate lines. Optionally, during the time period of displaying a frame of image, the method of providing each of N numbers of data signals includes sequentially providing one gate scanning signal after another to one gate line after another to progressively turn on one connection after another between a data line and one pixel electrode in the display panel starting from a first region of the N non-overlapping regions to an N-th region of the N non-overlapping regions. The first region is most proximal to the data source and the N-th region is most distal to the data source. Additionally, the method includes inputting each of one or more data signals with a same slew rate progressively to each of one or more pixel electrodes in each region of the N non-overlapping regions through each of one or more connections timely turned on by each corresponding one or more gate scanning signals. Furthermore, the method includes inputting each of one or more data signals with an increased slew rate progressively to each of one or more pixel electrodes in each next region of the N non-overlapping regions adjacent to the one region more distal to the data source through each of one or more connections timely turned on by each corresponding one or more gate scanning signals. The each region starts from the first region and the each next region ends at the N-th region.

Optionally, each of the N non-overlapping regions includes a same number of one or more gate lines.

Optionally, some of the N non-overlapping regions include different numbers of gate lines. A region proximal to borders of the display panel has a higher number of gate lines than a region distal to the borders of the display panel.

Optionally, the increased slew rate of a data signal applied to the each next region is obtained by multiplying a constant ratio greater than 1 to the slew rate of a data signal inputted to the each region.

Optionally, the data signal with the increased slew rate includes a quasi-square pulse with a shortened rising edge duration.

Optionally, each of the N numbers of data signals includes a quasi-square pulse with a rising edge. A data signal among the N numbers of data signals having a longest rising edge duration is applied first during the time period of displaying a frame of image. The longest rising edge duration is approximately 30% or more of a duration of the data signal applied on each pixel electrode in the first region.

Optionally, each of the N numbers of data signals includes a quasi-square pulse with a rising edge. A data signal among the N numbers of data signals having a shortest rising edge duration is applied last during the time period of displaying a frame of image. The shortest rising edge duration is approximately 1% or less of a duration of the data signal applied on each pixel electrode in the N-th region.

Optionally, the first region and the second region are adjacent to each other.

Optionally, the second region is a region most distal to the data source.

Optionally, each of the N non-overlapping regions includes one or more gate lines. Optionally, during the time period of displaying a frame of image, the method of providing N numbers of data signals includes sequentially providing one gate scanning signal after another to one gate line after another to progressively turn on one connection after another between a data line and one pixel electrode in the display panel starting from a first region of the N non-overlapping regions to an N-th region of the N non-overlapping regions. The first region is most distal to the data source and the N-th region is most proximal to the data source. Additionally, the method includes inputting each of one or more data signals with a same slew rate progressively to each of one or more pixel electrodes in each region of the N non-overlapping regions through each of one or more connections timely turned on by each corresponding one or more gate scanning signals. Furthermore, the method includes inputting each of one or more data signals with a decreased slew rate progressively to each of one or more pixel electrodes in each next region of the N non-overlapping regions adjacent to the one region more proximal to the data source through each of one or more connections timely turned on by each corresponding one or more gate scanning signals. The each region starts from the first region and the each next region ends at the N-th region.

Optionally, the decreased slew rate of a data signal applied to the each next region is obtained by multiplying a constant ratio smaller than 1 to the slew rate of a data signal inputted to the each region.

Optionally, the data signal with the decreased slew rate comprises a quasi-square pulse with an extended rising edge duration.

Optionally, each of the N numbers of data signals includes a quasi-square pulse with a rising edge. A data signal among the N numbers of data signals having a longest rising edge duration is applied last during the time period of displaying a frame of image. The longest rising edge duration is approximately 30% or more of a duration of the data signal applied on each pixel electrode in the N-th region.

Optionally, each of the N numbers of data signals includes a quasi-square pulse with a rising edge. A data signal among the N numbers of data signals having a shortest rising edge duration is applied first during the time period of displaying a frame of image. The shortest rising edge duration is approximately 1% or less of a duration of the data signal applied on each pixel electrode in the first region.

Optionally, each of the N non-overlapping regions includes one or more gate lines. Optionally, during the time period of displaying a frame of image, the method of providing N numbers of data signals includes sequentially providing one gate scanning signal after another on one gate line after another to progressively turn on one connection after another between a data line and one pixel electrode in the display panel starting from a first region of the N non-overlapping regions to an N/2-region of the N non-overlapping regions, and at substantially same time sequentially providing one gate scanning signal after another on one gate line after another to progressively turn on one connection after another between a data line and one pixel electrode in the display panel starting from an N-th region of the N non-overlapping regions to an (N/2+1)-th region of the N non-overlapping regions. The first region is more proximal to the data source and the N-th region is more distal to the data source. Optionally, the method additionally includes inputting each of one or more data signals with a same slew rate progressively to each of one or more pixel electrodes in each region of the N non-overlapping regions through each of one or more connections timely turned on by each corresponding one or more gate scanning signals. Furthermore, the method includes inputting each of one or more data signals with an increased slew rate progressively to each of one or more pixel electrodes in each next region of the N non-overlapping regions adjacent to the one region more distal to the data source through each of one or more connections timely turned on by each corresponding one or more gate scanning signals. The each region starts from the first region and the each next region ends at the N/2-th region. Moreover, the method includes inputting each of one or more data signals with a decreased slew rate progressively to each of one or more pixel electrodes in each next region of the N non-overlapping regions adjacent to the one region more proximal to the data source through each of one or more connections timely turned on by each corresponding one or more gate scanning signals, wherein the each region starts from the N-th region and the each next region ends at the (N/2+1)-th region.

In another aspect, the present disclosure provides a data source including a chip including a plurality of signal generators respectively coupled to a plurality of data lines in the a display panel. Each signal generator is configured to generate and input multiple data signals with different slew rates respectively to different pixel electrodes in different regions along each gate line. The data signals sent to corresponding pixel electrodes in a first region that is more distal to the data source is set to a higher slew rate than the data signals sent to corresponding pixels in a second region that is more proximal to the data source during a time period of displaying a frame of image.

In another aspect, the present disclosure provides a display apparatus including the data source described herein.

### BRIEF DESCRIPTION OF THE FIGURES

The following drawings are merely examples for illustrative purposes according to various disclosed embodiments and are not intended to limit the scope of the present invention.

FIG. 1 is a structural diagram of conventional display panel.

FIG. 2 is a schematic diagram showing signals applied through gate lines, data lines, and charged on pixel electrodes of the display panel in FIG. 1.

FIG. 3 is a structural diagram of a display panel configured to apply the method of FIG. 3 according to an embodiment of the present disclosure.

FIG. 4 is a schematic diagram showing signals applied through gate lines, data lines, and charged on pixel electrodes of the display panel of FIG. 3 according to an embodiment of the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

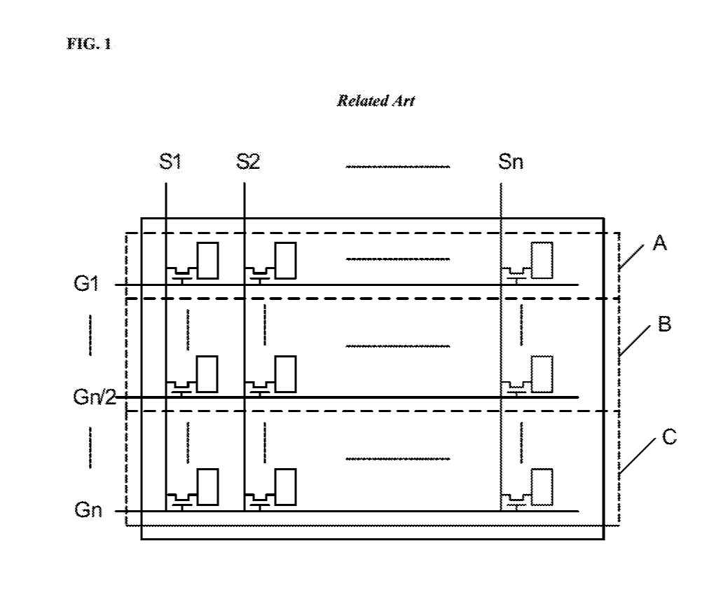

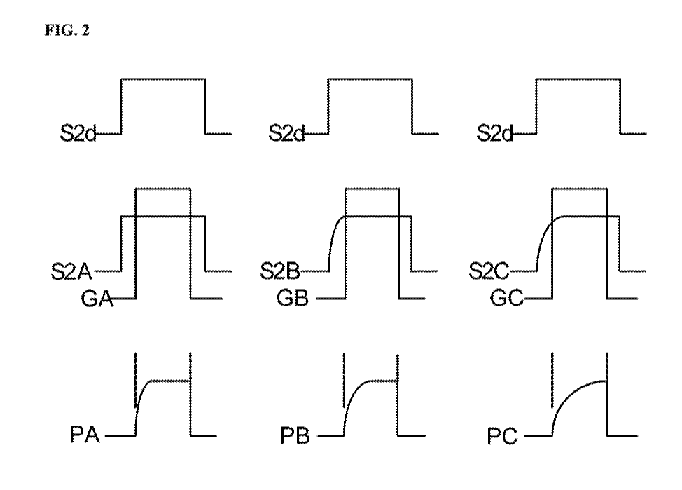

FIG. 1 is a structural diagram of conventional display panel. As shown, the display panel is divided to A, B, C three regions along the data line direction such that a distance from input terminals of the data signals is increasing in the order of A region, B region, and C region. FIG. 2 is a schematic diagram showing signals applied through gate lines, data lines, and charged on pixel electrodes of the display panel in FIG. 1. Referring to FIG. 2, a same data signal S2d is applied to multiple pixel electrodes through A, B, and C regions connected to a data line S2. Because the parasitic capacitances of the data line S2 at different sections through A, B, and C regions are different, an actual data signal S2B transmitted to the B region has a phase delay relative to original data signal S2d that is greater than a phase delay of an actual data signal S2A transmitted to the A region. Similarly, a phase delay of actual signal data S2C transmitted to the C region relative to the original data signal S2d is also greater than the phase delay of the actual data signal S2B transmitted to the B region. Thus, as the gate lines located inside A, B, C regions are respectively applied with gate scanning signal GA, GB, GC, the charging times for loading data signals respectively into pixel electrodes in A, B, C regions via data line S2 are also different. In particular, the charging time for loading a PA signal into pixel electrodes in A region is the longest. The charging time for loading a PB signal into pixel electrodes in B region is second to that. The charging time for loading a PC signal into pixel electrodes in C region is the shortest, leading to the darkest display brightness in C region.

Therefore during the charging process on pixel electrodes, delays exist for transmitting data signals to the different pixel electrodes in different regions. Particularly, different rows of pixel electrodes have different charging delays within one display cycle, causing non-uniformity issue of display brightness and image quality of the liquid crystal display device. As the development trend for the liquid crystal display panel continues goes a direction of large screen size and high resolution, the variation of data signal transmission delay along the data lines becomes a more serious issue to make the non-uniformity issue of display brightness even worse.

Accordingly, the present invention provides, inter aria, a method for driving a display panel, a data source, and a display apparatus that substantially obviate one or more of the problems due to limitations and disadvantages of the related art. In one aspect, the present disclosure provides a method for driving a thin-film transistor liquid crystal display panel for reducing charging delay variation among different rows of pixel electrodes of the display panel. The method includes applying a data signal one after another with an increasing stew rate via a data line to one or more pixel electrodes connected to the same data line in each display cycle time. The slew rate of a voltage signal is defined as the rate of change of the voltage per unit time. The method is aimed to enhance display brightness uniformity of the display panel.

In some embodiments, in order to facilitate adjustment of the slew rate of the data signal, the display panel is divided into N non-overlapping regions extended along the data lines. Here N is an integer greater than or equal to 2 and smaller than or equal to total number of gate lines in the display panel. Each of the N non-overlapping regions includes at least one gate line. Each gate line connects to a gate terminal of a thin-film transistor for controlling a connection between a data line and a pixel electrode. Optionally, a first region of the N non-overlapping regions is a located nearest in distance relative to the data source coupled to an input port for inputting the data signal in the data line. An N-th region of the N non-overlapping regions is located farthest in distance relative to the data source.

In some embodiments, during each time period of displaying a frame of image, all gate lines of the display panel are sequentially applied one gate scanning signal after another to progressively turn on one connection after another between the data line and one pixel electrode in all N non-overlapping regions starting from a first region to an N-th region. Optionally, as the gate scanning is in progress, each of one or more data signals with a same slew rate is inputted from the data source progressively to each of one or more pixel electrodes in each region of the N non-overlapping regions through each of one or more connections timely turned on by each corresponding one or more gate scanning signals. Optionally, each of one or more data signals with an increased slew rate is additionally inputted progressively to each of one or more pixel electrodes in each next region of the N non-overlapping regions adjacent to the one region more distal to the data source through each of one or more connections timely turned on by each corresponding one or more gate scanning signals. Here, the each region starts from the first region and the each next region ends at the N-th region. Optionally, each of the N regions includes a same number of one or more gate lines. Optionally, each of the N regions includes different number of gate lines.

In some embodiments, the method of applying a data signal described above includes, in the time period of displaying a frame of image, firstly providing one gate scanning signal after another sequentially on one gate line after another to turn on one or more pixel electrodes progressively from the first region that is the most proximal to the data source to the N-th region that is the most distal to the data source. Then, the method includes timely applying a data signal with a slew rate increasing from a first rate to a N-th rate separately to the one or more pixel electrodes progressively from the first region to the N-th region. Physically, a parasitic capacitance formed in the data line is proportional to its length measured from the input port of the data line. Different parasitic capacitance values cause different charging delays of the pixel electrodes at different rows of the pixel array of the display panel. In the present invention, the data signal with a higher slew rate is applied to pixel electrode located farther from the input port can still overcome larger charging delay to due to larger parasitic capacitance. In a specific embodiment, each of the N regions are equally set, and the slew rate for the data signal is increased proportionally from the first rate to the N-th rate so that the data signal transmitted to any location near the input port has similar phase delay as that transmitted to another location far from the input port. Therefore, multiple pixel electrodes that are connected to the same data line will be charged with a similar charging time by the data signal provided by the data source from the input port, ensuring that the display brightness uniformity of the display panel.

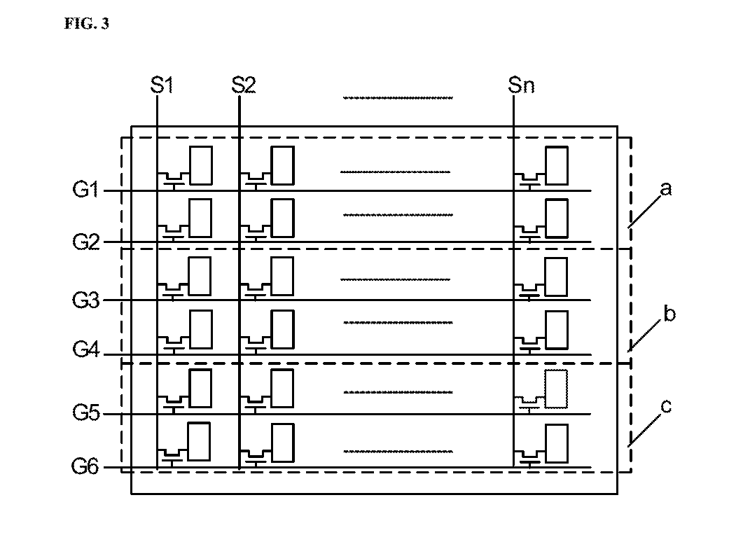

As an example, FIG. 3 shows a structural diagram of a display panel according to an embodiment of the present disclosure. As shown, the display panel is divided into three regions denoted as a, b, and c. Each region includes two gate lines. a region is the nearest in distance relative to an input port (located at top edge of the display panel to couple with a data source, not shown in FIG. 3) of the data line 82 for loading the data signal, i.e., a region is the first region. c region is the farthest in distance relative to the input port of the data line S2. Optionally, in each time period of displaying a frame of image, the gate lines G1-G6 in the three regions a, b, and c are turned on one by one sequentially by applying a gate scanning signal on each corresponding gate line. Optionally, the gate scanning can be performed in opposite order from G6 to G1 for providing a gate scanning signal first to G6, the farthest gate line relative to an input port, and providing a gate scanning signal last to G1, the nearest gate line relative to the input port.

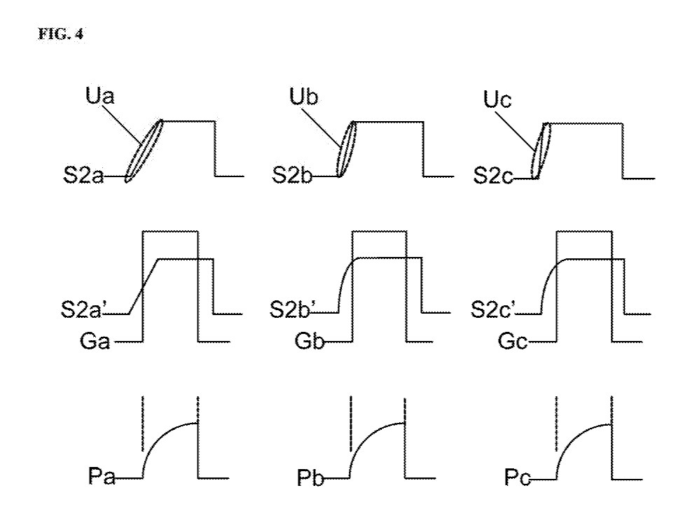

FIG. 4 is a schematic diagram showing signals applied through gate lines, data lines, and charged on pixel electrodes of the display panel of FIG. 3 according to an embodiment of the present disclosure. Referring to FIG. 4, a first data signal S2a is applied with a first slew rate to all pixel electrodes corresponding to the a region, a second data signal. S2b is applied with a second slew rate to all pixel electrodes corresponding to the b region, and a third data signal S3c is applied with a third slew rate to all pixel electrodes corresponding to the c region. Here, the third slew rate of the third data signal S2c is set to be greater than the second slew rate of the second data signal S2b. The second slew rate of the second data signal S2b is greater than the first slew rate of the first data signal S2a. In each region, e.g., a region, the data signals respectively applied to the two pixel electrodes via two connections turned on by G1 and G2 have a same slew rate. In some embodiments, the display panel can be divided along the extension direction of the data line 82 to two or greater than three regions. The maximum number of regions is equal to the total number of gate lines, i.e., each region includes one gate line.

Optionally, for effectively enhancing display brightness uniformity of the display panel, it is advantageous to divide the display panel to N regions along the data line such as each of the N regions has a same number of gate lines. For example, as shown in FIG. 3, the display panel is divided into three regions, each region including two gate lines. Optionally, based on different total number of gate lines of the display panel, each region can include other but equal number of gate lines. Optionally, some of the N regions can include different numbers of gate lines. Since human eyes are less sensitive to image abnormity in regions near the border of a display panel than that near middle area of the display panel. The data signal slew rate can be kept the same over more gate lines in each region near border area of the display panel, while the data signal slew rate adjustment can be more frequent from one region to next region near the middle area of the display panel by keeping the number of gate lines small in each region there. Referring to FIG. 3, if a region and c region are regions near the border of display panel, each of them can contain more gate lines where no data signal slew rate is changed over more gate lines. For b region that is near the middle area of the display panel, it contains less number of gate lines, for example, 1 or 2 gate lines, so that the data signal slew rate only is kept the same for the 1 or 2 gate lines in one region and can be increased in the next region. In this configuration, both the display quality improvement with data signal slew rate adjustment and the efficiency of signal adjustment are compromised economically.

Optionally, the N regions cover entire display panel continuously and non-overlappingly. Each gate line is only included into one region. For any two adjacent regions, a last gate line in one region is an adjacent gate line of the first gate line in the next region. For the regions near the border of the display panel, they can include more gate lines to accept data signal with a same slew rate as human eyes are less sensitive to pixel image variations in those area. For the regions near the middle area of the display panel, it is preferred to set the regions containing less gate lines to allow the data signal to change corresponding slew rate more frequently from one region to next.

Optionally, for effectively reducing charging time variation of pixel electrodes in each region, the method of applying a data signal described above includes, in each time period of displaying a frame of image, as the one or more gate lines in each region are turned on one by one, timely applying a data signal with a slew rate increased from a first rate to a N-th rate separately to the one or more pixel electrodes corresponding to the first region most proximal to a data source to the one or more pixel electrodes corresponding to the N-th region most distal to the data source. In particular, the data source is provided as a chip which includes a plurality of signal generators that can be programmed to generate data signals with the slew rate increased proportionally from the first rate sent to data lines in the first region to the N-th rate sent to data lines in the N-th region. For example, in FIG. 4, the slew rate of data signal S2a (applied first), the slew rate of data signal S2b, and the slew rate of data signal S2c are sequentially increased proportionally with a constant ratio >1.

In some embodiments, each of the N numbers of data signals comprises a quasi-square pulse with a rising edge. In a specific embodiment, applying a data signal one after another with an increasing slew rate via a data line to one or more pixel electrodes connected to the same data line can be realized by applying multiple data signals with a gradually shortened rising edge duration separately into the one or more pixel electrodes progressively from a proximal region to a distal region relative to an input port of the data signals thereof within each time period of displaying a frame of image.

Optionally, the method of applying a data signal described above includes, in each time period of displaying a frame of image, as the one or more gate lines in each region are turned on one by one, timely applying a data signal with a slew rate decreased from a first rate to a N-th rate separately to the one or more pixel electrodes corresponding to the first region most distal to a data source to the one or more pixel electrodes corresponding to the N-th region most proximal to the data source. In particular, the slew rate of the data is decreased proportionally from the first rate to the N-th rate. For example, in FIG. 4, the slew rate of data signal S2c (applied first), the slew rate of data signal S2b, and the slew rate of data signal S2a are sequentially decreased proportionally with a constant ratio <1.

Optionally, the method of applying a data signal described above includes, in each time period of displaying a frame of image, as the one or more gate lines in each region are turned on one by one, timely applying a data signal with a slew rate increased from a first rate to a N/2-th rate separately to the one or more pixel electrodes corresponding to the first region most proximal to a data source to the one or more pixel electrodes corresponding to the Ni/2-th region more distal to the data source. At a substantially the same time, the method also includes applying a data signal with a slew rate decreased from a first rate to a (N/2+1)-th rate separately to the one or more pixel electrodes corresponding to the N-th region most distal to a data source to the one or more pixel electrodes corresponding to the (N/2+)-th region less distal to the data source. In particular, the slew rate of the data is increased proportionally from the first rate to the N/2-th rate and is decreased proportionally from the N-th rate to the (N/2+1)-th rate. In other words, the frame of image is obtained by scanning gate lines from top (a first gate line) to middle (a gate line near middle area of the display panel) and simultaneously from bottom (a last gate line) to middle (another gate line near middle area of the display panel) for achieving higher refresh rate of the frame of images. Of course, the scanning of gate lines from top down can end at any gate line not exactly at middle of the display panel and the scanning of gate lines from bottom up can also end at any gate line next to the previous one ended by scanning from top down.

In a specific embodiment, applying a data signal one after another with an increasing slew rate via a data line to one or more pixel electrodes connected to the same data line can be realized by applying multiple data signals with a gradually extended rising edge duration separately into the one or more pixel electrodes progressively from a distal region to a proximal region relative to an input port of the data signals thereof within each time period of displaying a frame of image.

For example, as shown in FIG. 4, within each time period of displaying a frame of image, S2a is the data signal applied to the pixel electrodes in a region that connect to the data line S2. S2b is the data signal applied to the pixel electrodes in b region that connect to the same data line S2, S2c is the data signal applied to the pixel electrodes in c region that connect to the same data line S2. Further, a duration of a rising edge Uc of the data signal S2c is shorter than that of a rising edge Ub of the data signal S2b. A duration of the rising edge Ub of the data signal S2b is further smaller than that of a rising edge Ua of the data signal S2a. Therefore, an actual data signal S2a′ transmitted to the pixel electrodes in the a region, an actual data signal S2b′ transmitted to the pixel electrodes in the b region, and an actual data signal S2c′ transmitted to the pixel electrodes in the c region all have a similar phase delay. As a result, among a charging time for loading a signal Pa into the pixel electrodes in the a region, a charging time for loading a signal Pb into the pixel electrodes in the b region, and a charging time for loading a signal Pc into the pixel electrodes in the c region, the difference is substantially small. This method of applying the data signal reduces display brightness variation yielded from pixels in different regions.

Optionally, within each time period of displaying a frame of image, the duration of the longest rising edge Ua of the data signal S2a can be 30% of the total duration of applying this data signal S2a to the corresponding pixel electrodes. Optionally, the duration the shortest rising edge Uc of the data signal S2c can be 1% of the total duration of applying this data signal S2c. This ensures that each pixel electrode in the whole display panel has a similar charging time so as to ensure the display brightness uniformity of the whole display panel.

In another aspect, the present disclosure provides a data source including a plurality of signal generators respectively coupled to a plurality of data lines of a thin-film transistor-based display panel. Each signal generator is configured to generate and input multiple data signals with different slew rates respectively to different pixel electrodes in different regions along each gate line according to the method of the present disclosure during a time period of displaying a frame of image. In other words, this data source is configured to provide data signal with changing slew rate along one or more data lines to drive the display panel of FIG. 3.

In yet another aspect, the present disclosure also provides a display apparatus including the display circuit mentioned above. Optionally, the display apparatus can be a mobile phone, a tablet computer, a TV, an image displayer, a laptop computer, a digital frame, a navigator and other products or components having a display function.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc, following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A method of driving a display panel comprising:
providing, during a time period of displaying a frame of image and through a data line, a first data signal having a first slew rate to a first pixel electrode in a first region and a second data signal having a second slew rate higher than the first slew rate to a second pixel electrode in a second region;
wherein the first pixel electrode in the first region and the second pixel electrode in the second region are coupled to the same data line, the second region being on a side of the first region distal to a data source configured to input the first data signal and the second data signal.

2. The method of claim 1, wherein the first data signal having the first slew rate in a first region is provided through a first data line and the second data signal having the second slew rate in the second region is provided through a second data line, wherein the second slew rate is higher than the first slew rate and the second region is on a side of the first region distal to the data source.

3. The method of claim 1, wherein providing the first data signal and the second data signal comprises providing each of N numbers of data signals with different slew rates respectively to a pixel electrode in one of N non-overlapping regions, wherein N is an integer greater than or equal to 2 and no greater than a total number of gate lines in the display panel;
wherein the pixel electrode in any of the N non-overlapping regions more distal to the data source is provided with one of the N numbers of data signals having a slew rate higher than that of one of the N numbers of data signals provided to the pixel electrode of the N non-overlapping regions more proximal to the data source.

4. The method of claim 3, wherein each of the N non-overlapping regions comprises one or more gate lines, wherein providing each of N numbers of data signals comprises, during the time period of displaying a frame of image,
sequentially providing one gate scanning signal after another to one gate line after another to progressively turn on one connection after another between a data line and one pixel electrode in the display panel starting from a first region of the N non-overlapping regions to an N-th region of the N non-overlapping regions, wherein the first region is most proximal to the data source and the N-th region is most distal to the data source;
inputting each of one or more data signals with a same slew rate progressively to each of one or more pixel electrodes in each region of the N non-overlapping regions through each of one or more connections timely turned on by each corresponding one or more gate scanning signals; and
inputting each of one or more data signals with an increased slew rate progressively to each of one or more pixel electrodes in each next region of the N non-overlapping regions adjacent to the one region more distal to the data source through each of one or more connections timely turned on by each corresponding one or more gate scanning signals, wherein the each region starts from the first region and the each next region ends at the N-th region.

5. The method of claim 4, wherein each of the N non-overlapping regions comprises a same number of one or more gate lines.

6. The method of claim 4, wherein some of the N non-overlapping regions comprise different numbers of gate lines, wherein a region proximal to borders of the display panel has a higher number of gate lines than a region distal to the borders of the display panel.

7. The method of claim 4, wherein the increased slew rate of a data signal applied to the each next region is obtained by multiplying a constant ratio greater than 1 to the slew rate of a data signal inputted to the each region.

8. The method of claim 7, wherein the data signal with the increased slew rate comprises a quasi-square pulse with a shortened rising edge duration.

9. The method of claim 4, wherein each of the N numbers of data signals comprises a quasi-square pulse with a rising edge, a data signal among the N numbers of data signals having a longest rising edge duration is applied first during the time period of displaying a frame of image, the longest rising edge duration being approximately 30% or more of a duration of the data signal applied on each pixel electrode in the first region.

10. The method of claim 4, wherein each of the N numbers of data signals comprises a quasi-square pulse with a rising edge, a data signal among the N numbers of data signals having a shortest rising edge duration is applied last during the time period of displaying a frame of image, the shortest rising edge duration being approximately 1% or less of a duration of the data signal applied on each pixel electrode in the N-th region.

11. The method of claim 1, wherein the first region and the second region are adjacent to each other.

12. The method of claim 1, wherein the second region is a region most distal to the data source.

13. The method of claim 3, wherein each of the N non-overlapping regions comprises one or more gate lines, wherein providing N numbers of data signals comprises, during the time period of displaying a frame of image,
sequentially providing one gate scanning signal after another to one gate line after another to progressively turn on one connection after another between a data line and one pixel electrode in the display panel starting from a first region of the N non-overlapping regions to an N-th region of the N non-overlapping regions, wherein the first region is most distal to the data source and the N-th region is most proximal to the data source;
inputting each of one or more data signals with a same slew rate progressively to each of one or more pixel electrodes in each region of the N non-overlapping regions through each of one or more connections timely turned on by each corresponding one or more gate scanning signals; and
inputting each of one or more data signals with a decreased slew rate progressively to each of one or more pixel electrodes in each next region of the N non-overlapping regions adjacent to the one region more proximal to the data source through each of one or more connections timely turned on by each corresponding one or more gate scanning signals, wherein the each region starts from the first region and the each next region ends at the N-th region.

14. The method of claim 13, wherein the decreased slew rate of a data signal applied to the each next region is obtained by multiplying a constant ratio smaller than 1 to the slew rate of a data signal inputted to the each region.

15. The method of claim 13, wherein the data signal with the decreased slew rate comprises a quasi-square pulse with an extended rising edge duration.

16. The method of claim 15, wherein each of the N numbers of data signals comprises a quasi-square pulse with a rising edge, a data signal among the N numbers of data signals having a longest rising edge duration is applied last during the time period of displaying a frame of image, the longest rising edge duration being approximately 30% or more of a duration of the data signal applied on each pixel electrode in the N-th region.

17. The method of claim 15, wherein each of the N numbers of data signals comprises a quasi-square pulse with a rising edge, a data signal among the N numbers of data signals having a shortest rising edge duration is applied first during the time period of displaying a frame of image, the shortest rising edge duration being approximately 1% or less of a duration of the data signal applied on each pixel electrode in the first region.

18. The method of claim 3, wherein each of the N non-overlapping regions comprises one or more gate lines, wherein providing N numbers of data signals comprises, during the time period of displaying a frame of image,
sequentially providing one gate scanning signal after another on one gate line after another to progressively turn on one connection after another between a data line and one pixel electrode in the display panel starting from a first region of the N non-overlapping regions to an N/2-th region of the N non-overlapping regions, and at substantially same time sequentially providing one gate scanning signal after another on one gate line after another to progressively turn on one connection after another between a data line and one pixel electrode in the display panel starting from an N-th region of the N non-overlapping regions to an (N/2+1)-th region of the N non-overlapping regions, wherein the first region is more proximal to the data source and the N-th region is more distal to the data source;
inputting each of one or more data signals with a same slew rate progressively to each of one or more pixel electrodes in each region of the N non-overlapping regions through each of one or more connections timely turned on by each corresponding one or more gate scanning signals;
inputting each of one or more data signals with an increased slew rate progressively to each of one or more pixel electrodes in each next region of the N non-overlapping regions adjacent to the one region more distal to the data source through each of one or more connections timely turned on by each corresponding one or more gate scanning signals, wherein the each region starts from the first region and the each next region ends at the N/2-th region; and
inputting each of one or more data signals with a decreased slew rate progressively to each of one or more pixel electrodes in each next region of the N non-overlapping regions adjacent to the one region more proximal to the data source through each of one or more connections timely turned on by each corresponding one or more gate scanning signals, wherein the each region starts from the N-th region and the each next region ends at the (N/2+1)-th region.

19. A data source comprising a chip including a plurality of signal generators respectively coupled to a plurality of data lines in a display panel, each signal generator is configured to generate and input multiple data signals with different slew rates respectively to different pixel electrodes in different regions along each gate line, the data signals sent to corresponding pixel electrodes in a first region that is more distal to the data source being set to a higher slew rate than the data signals sent to corresponding pixels in a second region that is more proximal to the data source during a time period of displaying a frame of image.

20. A display apparatus comprising a data source of claim 19.
